(19) United States
(12) Patent Application Publication
(10) Pub. No.: US 2018/0056774 A1
(43) Pub. Date: Mar. 1, 2018

(54) Wheel Hubs and Power Wheels Containing the Same

(71) Applicant: Foster Assets Corporation, Kowloon (HK)

(72) Inventor: Yet Chan, Kowloon (HK)

(73) Assignee: Foster Assets Corporation, Kowloon (HK)

(21) Appl. No.: 15/251,685

(22) Filed: Aug. 30, 2016

(51) Int. Cl. B60K 7/00; B60K 17/14; B60K 17/02

(52) U.S. Cl. CPC B60K 7/0007; B60K 17/145; B60Y 2200/13; B60K 2007/0092; B60K 17/02

(57) ABSTRACT

A wheel hub capable of being coupled to an axle of a wheel such that the wheel hub is rotatable around the axle. The wheel hub includes a hub housing adapted to be rotatably supported on the axle, and a motor including a stator and a rotor. The stator is adapted to be fixedly connected to the axle. The rotor is configured to be rotatable with respect to the stator. The rotor includes a circular rotor housing inside which a gear reduction module is located. The output of the gear reduction module is connected to a one-way transmission module which in turn is adapted to drive the hub housing to rotate. As the gear reduction module and the one-way transmission module are contained within the rotor, the size of the power wheel can be reduced without sacrificing the performance.

### FIELD OF INVENTION

This invention relates to vehicle wheels which are self-propelled, and which are suitable for installing on bicycles, tricycles and four-wheel vehicles.

### BACKGROUND OF INVENTION

Many modern bicycles and other types of light vehicles are designed to use electric power for driving the wheels to advance, as a replacement of manual pedaling or as a supplement to it. For example, self-propelled wheels which are also known as power wheels, are installed on such bicycles which do not need an external motor and/or battery mounted on the bicycle frame, since the power wheels themselves contain internal motors and rechargeable batteries. Bicycles equipped with one or two power wheels usually have a similar appearance as conventional manual-pedaling bicycles due to the integrated design of power wheels with no exposed components. All the essential components of a power wheel are usually accommodated within a wheel hub located at the center of the power wheel.

In order for the motor in the power wheel to drive the power wheel, the typical high-speed and low-torque output of the motor must be converted to a low-speed and high-torque rotational force in order to drive the power wheel. Well-known mechanisms like gear reduction modules and one-way transmission means are used to couple the motor to the power wheel in order to perform such conversions. However, in conventional power wheels a substantial portion of the space inside hub of the power wheel has to be used to place the gear reduction modules and/or the one-way transmission means. Such configurations no doubt increase the overall size of the power wheel hub and make the appearance of the power wheel less appealing.

### SUMMARY OF INVENTION

In the light of the foregoing background, it is an object of the present invention to provide an alternate power wheel and it wheel hub structure which eliminate or at least alleviate the above technical problems.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention in one aspect is a wheel hub capable of being coupled to an axle of a wheel such that the wheel hub is rotatable around the axle. The wheel hub includes a hub housing adapted to be rotatably supported on the axle, and a motor including a stator and a rotor. The stator is adapted to be fixedly connected to the axle. The rotor is configured to be rotatable with respect to the stator. The rotor includes a circular rotor housing inside which a gear reduction module is located. The output of the gear reduction module is connected to a one-way transmission module which in turn is adapted to drive the hub housing to rotate.

Preferably, the gear reduction module further includes an eccentric gear module. An input of the eccentric gear module is connected to the rotor housing. An output of the eccentric gear module is connected to the one-way transmission module.

More preferably, the eccentric gear module further includes an eccentric gear adapted to be rotatably supported on the axle. The eccentric gear is fixedly connected to the rotor housing and being drivable by the latter to rotate.

According to one variation of the preferred embodiments, the eccentric gear is coupled to an external ring gear via a connecting member. The external ring gear is adapted to revolve within an internal ring gear fixedly mounted on the hub housing.

According to another variation of the preferred embodiments, the external ring gear includes external teeth; the internal ring gear including internal teeth. Only a part of the external teeth engages with only a part of the internal teeth at any time. The external ring gear has a central axis offset from that of the internal ring gear.

According to a further variation of the preferred embodiments, the number of the external teeth is smaller than that of the internal teeth.

In one implementation, the external ring gear is coupled to an output carrier to drive the latter to rotate. The output carrier is coupled to the one-way transmission module to provide the output of the gear reduction module thereto. The output carrier has a same axis of rotation with the rotor.

In another implementation, the gear reduction module is a planetary gear module. An input of the planetary gear module is connected to an output shaft of the motor. An output of the planetary gear module is connected to the hub housing.

Preferably, the planetary gear module further includes a sun gear adapted to be rotatably supported on the axle. The sun gear is fixedly connected to the rotor housing and being drivable by the latter to rotate.

More preferably, the sun gear is coupled to a plurality of planetary gears confined by an internal ring gear fixedly mounted on the hub housing. The planetary gears are adapted to revolve around the sun gear within the internal ring gear.

According to one variation of the preferred embodiments, the plurality of planetary gears is coupled to an output carrier to drive the latter to rotate. The output carrier is coupled to the one-way transmission module to provide the output of the gear reduction module thereto. The output carrier has a same axis of rotation with the axle.

According to another variation of the preferred embodiments the one-way transmission module is a one-way transmission clutch.

Alternatively, the one-way transmission module is a one-way bearing supporting the gear reduction module on the hub housing.

In one implementation, the one-way bearing is at least partially received in the rotor housing.

In another implementation, the wheel hub further includes a sprocket fixedly connected to the housing. The sprocket is adapted to be connected to and driven by an external chain.

According to another aspect of the present invention, there is disclosed a power wheel which is adapted to be coupled to a vehicle frame. The power wheel includes an axle for connecting the power wheel to the vehicle frame, a wheel hub, and a rim fixedly connected to a hub housing of the wheel hub. The wheel hub includes a hub housing adapted to be rotatably supported on the axle, and a motor including a stator and a rotor. The stator is adapted to be fixedly connected to the axle. The rotor is configured to be rotatable with respect to the stator. The rotor includes a circular rotor housing inside which a gear reduction module is located. The output of the gear reduction module is connected to a one-way transmission module which in turn is adapted to drive the hub housing to rotate.

Preferably, the power wheel further includes a plurality of spokes; the housing of the wheel hub connected to the rim by the plurality of spokes.

According to a further aspect of the present invention, there is disclosed a wheel hub capable of being coupled to an axle of a wheel such that the wheel hub is rotatable around the axle. The wheel hub includes a hub housing adapted to be rotatably supported on the axle, and a motor including a stator and a rotor. The stator is adapted to be fixedly connected to the axle. The rotor configured to be rotatable with respect to the stator. The rotor includes a rotor housing. The rotor further includes a one-way transmission module and a bearing which are located within the rotor housing.

Preferably, the one-way transmission module and the bearing couple the rotor to an output carrier. The output carrier is fixedly connected to the hub housing and adapted to drive the latter to rotate with respect to the axle.

More preferably, the one-way transmission module and the bearing are aligned along an axial direction of the motor.

In one implementation, the one-way transmission module is a one-way bearing.

According to a further aspect of the present invention, there is disclosed a power wheel which is adapted to be coupled to a vehicle frame. The power wheel includes an axle for connecting the power wheel to the vehicle frame, a wheel hub, and a rim fixedly connected to a hub housing of the wheel hub. The wheel hub includes a hub housing adapted to be rotatably supported on the axle, and a motor including a stator and a rotor. The stator is adapted to be fixedly connected to the axle. The rotor configured to be rotatable with respect to the stator. The rotor includes a rotor housing. The rotor further includes a one-way transmission module and a bearing which are located within the rotor housing.

There are many advantages to the present invention. Firstly, by positioning the gear reduction modules and one-way transmission mechanisms within the rotor of the motor rather than placing them outside of the motor, the overall size of the wheel hub is significantly reduced in particular in terms of the width (that is, the distance between the two side covers of the wheel hub housing). The power wheels according to the present invention therefore has a smaller width, and can be made more like conventional bicycle wheels (i.e. non-power wheel type), which are visually appealing to the users. At the same time, the performance of the power wheel is not sacrificed, as the speed reduction and one-way clutch modules are kept in the power wheels.

From another point of view, placing the gear reduction modules and one-way transmission mechanisms within the rotor, means that for the same overall size of the wheel hub, the motor itself is allowed to have a larger size, and inherently achieves a better performance. It is appreciated by those skilled in the art that a larger motor (which would have for example more coil windings on the stator teeth, and more magnets on the rotor) outputs a stronger rotational force with higher speed and larger torque due to the enhanced magnetic field intensity. Therefore, the power wheels in the present invention can be varied to accommodate larger motors to improve the performance of the power wheels, without the need to compromise for form factors.

The power wheel provided by the present invention is particularly useful for the next-generation four-wheel vehicles. Compared to traditional vehicles in which the mechanical driving force comes from an internal combustion engine and/or a central electric motor, vehicles equipped with the power wheels can completely get rid of any engine or motor that occupies the front engine compartment in the vehicle. The number of power wheels can be two or four for example, depending on whether the vehicle is a 2-wheel drive type or a 4-wheel drive type. A central controller in the vehicle is used to control the power wheels so that each wheel of the vehicle can output different torque. In other words, there is no more “torque split” as in the conventional vehicles, but instead the torque of each wheel can be adjusted when needed. Such a configuration is useful for off-road vehicles in which the adjustable torque is required to overcome various terrain difficulties. In addition, since there is no centralized engine or motor, there is no need for the mechanical transmission system in the vehicle. The vehicle equipped with power wheels is therefore less prone to mechanical failure, and at the same time provide more inner space for the passengers and/or cargo.

### BRIEF DESCRIPTION OF FIGURES

The foregoing and further features of the present invention will be apparent from the following description of preferred embodiments which are provided by way of example only in connection with the accompanying figures, of which:

FIG. 1 is a front view of the power wheel according to a first embodiment of the present invention.

FIG. 2 is a side cross-sectional view of the wheel hub in the power wheel shown in FIG. 1; which contains an eccentric gear module.

FIG. 3 shows engagement relationship of the external ring gear and internal ring gear in the gear reduction module in the wheel hub of FIG. 2.

FIG. 4 is a side cross-sectional view of the wheel hub according to another embodiment of the present invention; the wheel hub including a planetary gear module.

FIG. 5 illustrates the planetary gear module in the wheel hub of FIG. 4.

FIG. 6 is a side cross-sectional view of the wheel hub according to further embodiment of the present invention; the wheel hub including no gear reduction mechanisms.

FIG. 7 is a side cross-sectional view of a motor in a power wheel according to a further embodiment of the present invention; the motor including a planetary gear module.

FIG. 8 illustrates the planetary gear module in the motor of FIG. 7.

FIG. 9 is a side cross-sectional view of a motor in a power wheel according to a further embodiment of the present invention; the motor including a planetary gear module.

FIG. 10 illustrates the planetary gear module in the motor of FIG. 9.

FIG. 11 is a side cross-sectional view of a motor in a power wheel according to a further embodiment of the present invention; the motor including a planetary gear module.

FIG. 12 is a side cross-sectional view of a power wheel according to a further embodiment of the present invention; the power wheel can be equipped on a four-wheel vehicle.

In the drawings, like numerals indicate like parts throughout the several embodiments described herein.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated.

Terms such as “horizontal”, “vertical”, “upwards”, “ downwards”, “above”, “below” and similar terms as used herein are for the purpose of describing the invention in its normal in-use orientation and are not intended to limit the invention to any particular orientation.

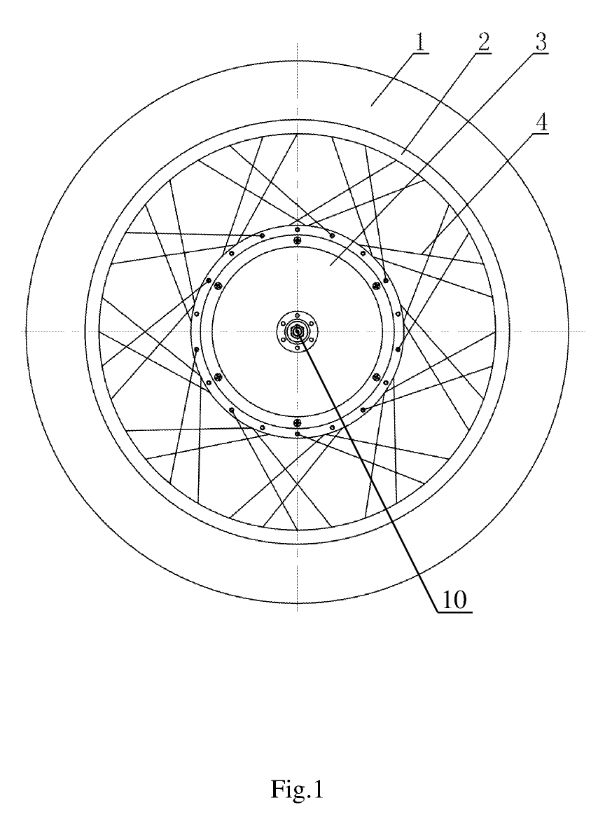

FIG. 1 shows a power wheel according to a first embodiment of the present invention. The power wheel includes a wheel tire 1, a rim 2, a wheel hub 3, and a plurality of spokes 4. The wheel hub 3 is connected to the rim 2 by the plurality of spokes 4, so that the rim 2 and the wheel hub 3 rotate together when the wheel hub 3 is driven to move by a mechanical force. To be able to rotate, the wheel hub 3 and in turn the rim 2 are rotatably supported on an axle 10 (which will be described in details later). The tire 1 covers the exterior surfaces of the rim 2 to protect the rim and enable better vehicle performance, as skilled persons in the art would appreciate. The power wheel in this embodiment is made to a dimension of a typical bicycle wheel, so that the power wheel can be used to replace a normal bicycle wheel on an existing bicycle by simply coupling the axle 10 to the frame or more specifically a dropout of the bicycle frame (not shown).

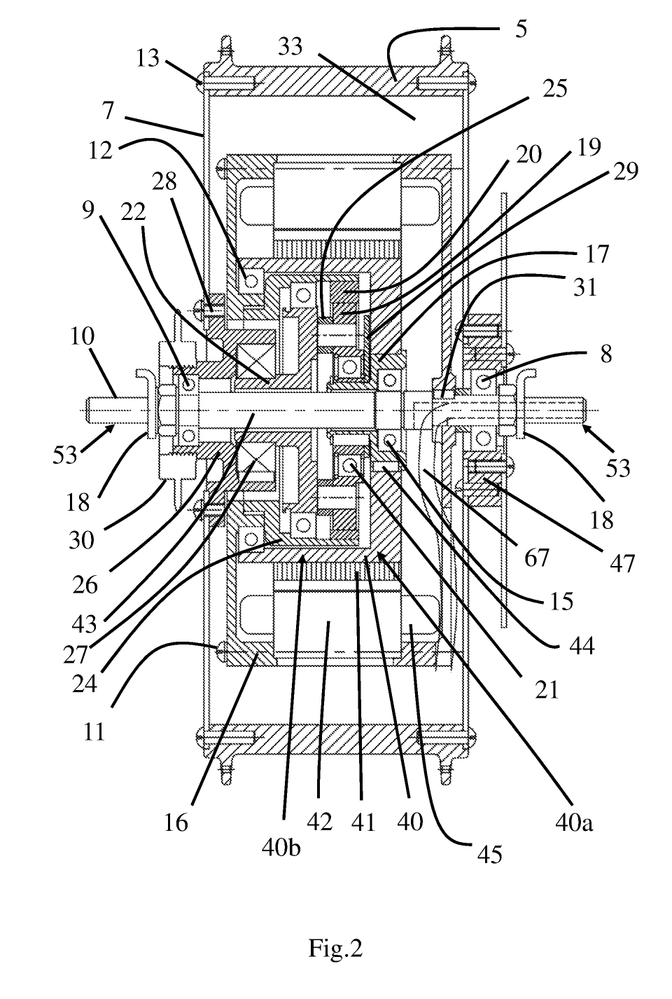

Turning now to FIG. 2, the housing of the wheel hub is defined by a circular top cover 5, and two side covers 7, all of which are connected to each other by screws 13 so as to form an integral piece. All the components necessary for the self-propelling operation of the power wheel are contained within the housing. The wheel hub housing is rotatably supported on the axle 10 by a first bearing 8 and a second bearing 9. The width of the housing, which is defined by the distance between the portions of the two side covers 7 separated furthest away, is larger than the width of the tire 1. The housing width is so determined in order for the housing to accommodate the motor, while other transmission mechanisms are accommodated within the motor and they do not occupy internal space in the wheel hub outside of the motor. On one end of the axle 10, there is configured a sprocket 30 which is fixed to the adjacent side cover 7 and rotatable together with the same. The sprocket 30 is capable of engaging with a chain (not shown) of a bicycle as those skilled in the art would understand.

The two ends 53 of the axle 10 are shaped to have a flattened cross-section, and in other words the two ends 53 have a cross-section of which the dimension along one orthogonal direction is different from the dimension along another orthogonal direction. Corresponding to such flattened cross-sectional shape of the axle ends 53, two hook washers 18 are configured to sleeve the two ends 53 of the axle 10 respectively through flattened openings (not shown) formed on the hook washers 18. The openings have a shape which is also flattened, and thus they are corresponding to the cross-sectional shape of the axle ends 53. Therefore, the axle 10 is prohibited from rotating with respect to the hook washers 18 due to the flattened axle ends 53 and the hook washers 18. The hook washers 18 are used to install the axle and the power wheel to the dropouts on a bicycle frame (not shown) as those skilled in the art would understand. Electric wires 67 connect the motor in the power wheel hub to external controllers and/or additional batteries which are typically mounted on the frame of the bicycle.

As shown in FIG. 2, the motor is contained within the hub housing at a center thereof. The size of the motor is defined by a motor housing 16 which has a similar form factor as the hub housing but only smaller than the hub housing. The motor housing 16 has a flat key 31 which fits to a corresponding recess portion (not shown) of the axle 10, so that the motor as a whole is firmly connected to axle 10 and not rotatable with respect to the axle 10. Between the motor and the top cover 5 as well as bottom cover 6, there are other internal spaces 33 which are used to place other components of the power wheel such as batteries (not shown). The motor housing 16 are consisted of several pieces (not shown individually) which are connected together by screws 11. The structure of the motor housing 16 is therefore similar to the housing of the wheel hub. Within the motor housing 16, there are contained a rotor 40 and a stator 42, which are coaxial with the axle 10 around a central axis 43. Coil windings 45 are configured on the stator 42 in a way well-known to those skilled in the art. The stator 42 is fixedly connected to the motor housing 16 and in turn fixedly connected to the axle 10 due to the flat key 31 mentioned above, so that both the stator 42 and the motor housing 16 remain still during operation of the power wheel. On the other side, the rotor 40 has a size defined by a rotor housing. The rotor housing has a circular shape which is similar to the shape of a conventional rotor. One can see from FIG. 2 that in this embodiment the rotor housing is consisted of a circumferential wall 40b and one side wall 40a at a first end of the rotor. However, there is no side wall forming the rotor housing 40 at a second end of the rotor opposite to the first end along the axial direction. Rather, the rotor 40 is rotatably supported on the motor housing 16 via a third bearing 12. There are magnets 41 arranged on top of the rotor housing 40 at an external surface of the circumferential wall 40b.

The power wheel hub as shown in FIG. 2 contains both a gear reduction module and a one-way transmission module, both of which are positioned within the rotor housing 40 such that no part of the gear reduction module and the one-way transmission module is external to the motor. In the gear reduction module, there is an eccentric gear 17 supported by a fourth bearing 15 on the axle 10, and as a result the eccentric gear 17 is rotatable relative to the axle 10. The eccentric gear 17 is further fixedly connected to the side wall 40a of the rotor housing via a flat key 44 and rotates at the same time with the rotor housing. In particular, the eccentric gear 17 is in a two-stepped tubular shape, a first segment of which is connected to the rotor housing and supported by the fourth bearing 15. A second segment of the eccentric gear 17 on the other end is coupled to an external ring gear 19. There is also a counterbalance member 29 fixed to the eccentric gear 17 to balance vibration caused by the eccentrically rotating of the eccentric gear 17. The rotation of the eccentric gear 17 causes the external ring gear 19 to move. At the same time, the external ring gear 19 is supported on the eccentric gear 17 via one or more fifth bearings 21. Note that both the first segment and second segment of the eccentric gear 17 have different thicknesses around their circumferential directions. Such inequality in thickness results in the eccentric gear 17 outputting an eccentric movement, as will be described in more details later.

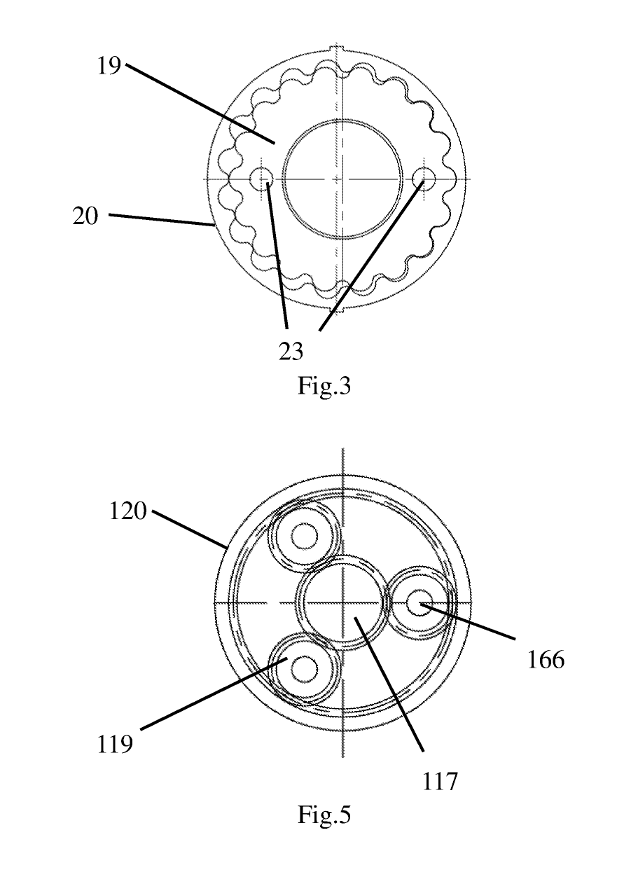

The external ring gear 19 is confined by an internal ring gear 20. FIG. 3 best illustrates the shape and mutual spatial relationship between the external ring gear 19 and the internal ring gear 20. The external ring gear 19 is adapted to revolve within the internal ring gear 20. The internal ring gear 20 is called as such since its teeth are formed at an interior circumferential surface of the internal ring gear 20. Correspondingly, the teeth of the external ring gear 19 are formed at an exterior circumferential surface of the external ring gear 19. The radius of the external ring gear 19 is smaller than that of the internal ring gear 20, and the number of teeth on the external ring gear 19 is also slightly less than that of the teeth on the internal ring gear 20. In the embodiment shown in FIG. 3, there are eighteen teeth on the external ring gear 19 but nineteen teeth on the internal ring gear 20. Due to difference in their sizes, the center of the external ring gear 19 is offset from that of the internal ring gear 20. The external ring gear 19 is adapted to revolve within the internal ring gear 20 but at any time, there are only a part of the teeth on the external ring gear 19 engaged with only a part of the teeth on the internal ring gear 20. At the moment as shown in FIG. 3, there are only three teeth from each of the external ring gear 19 and the internal ring gear 20 which are completely engaged. There are two mounting holes 23 formed on the external ring gear 19 for coupling to an output of the gear reduction module, which will be described in more details later.

Turning back to FIG. 2, the internal ring gear 20 is fixed to the gear support 24 which in turn is fixed to the motor housing 16. As a result, the internal ring gear 20 is not adapted to rotate. Bushings 25 are mounted to the external ring gear 19 at mounting holes 23 as described above. The bushings 25 couple the external ring gear 19 to one end of an output carrier 22. The output carrier 22 is rotatably supported on the gear support 24 via one or more sixth bearings 35. The output carrier 22 is configured to rotate relative to the axle 10 but is not directly connected to the axle 10. The other end of the output carrier 22 is supported by a one-way transmission mechanism on a connecting flange 26. The one-way transmission mechanism in this embodiment is a one-way clutch 27. The connecting flange 26 is fixed to the side cover 7 of the hub housing by screws 28. The connecting flange 26 and the hub housing therefore rotate at the same time. On the other end of the axle 10, there is connected a braking flange 47 which is fixedly connected to the wheel hub housing.

The one-way clutch 27 can adopt any known structures as appreciated by skilled persons in the art. As an exemplary implementation only, the one-way clutch 27 could include a flywheel which have a follower (e.g. a ratchet) and a driving part (e.g. a ring gear), all of which are not shown in the drawings. As those skilled would understand, the follower will be driven by the driving part to rotate only when the rotational speed of the driving part is larger than that of the follower. Conversely, when the follower rotates at a speed larger than that of the driving part, the follower slips over the driving part and not causing the latter to rotate.

Now turning to the operation of the power wheel described above. With reference to FIG. 2, during operation the rotor of the motor in the power wheel once energized will start to rotate around the central axis 43 due to change of magnetic flux between the stator 42 and the rotor 40. Rotation of the rotor means that the rotor housing on which the magnets 41 are fixed rotates relative to the axle 10. Next, as the eccentric gear 17 is fixedly connected to the rotor housing 40, the eccentric gear 17 rotates around the central axis 43. However, due to the eccentric shape of the eccentric gear 17 as described above, the eccentric gear 17 transmits an eccentric driving force to the external ring gear 19 via the connecting member 29. As the external ring gear 19 is limited within the fixed internal ring gear 20, and that only parts of their teeth engage at any time, the external ring gear 19 revolves within the internal ring gear 20 as a result of the eccentric gear 17 rotating. The fifth bearing 21 provides supports for the external ring gear 19 during its revolving action. The revolving movement of the external ring gear 19 is then transmitted to the output carrier 22 via the bushings 25. The rotation of output carrier 22 is again concentric with that of the rotor 40. Note that the rotational speed of the output carrier 22 is smaller than that of the rotor 40 due to the engagement of various gears described above which have different shapes and number of teeth, and in particular that the number of teeth on the external ring gear 19 is slightly less than that of the teeth on the internal ring gear 20. The ratio of gear speed reduction can be configured as desired, for example in the range of 10% to 50%. The output carrier 22 then drives the connecting flange 26 to rotate via the one-way clutch 27, if the power wheel does not rotates or rotates at a speed slower than that of the connecting flange 26. In this case the one-way clutch 27 operates to transmit the power from the output carrier 22 to the connecting flange 26. The connecting flange 26 is fixed to the hub housing and in turn to the sprocket 30, so rotation of the connecting flange 26 causes the power wheel to rotate, thus moving the bicycle installed with the power wheel forward. During the whole process the axle 10 is always still.

However, if the motor in the power wheel rotates, but the power wheel rotates at a speed even faster than that of the speed of the connecting flange 26, then the one-way clutch 27 is disabled and does not transmit the power from the output carrier 22 to the connecting flange 26. In consequence, the (faster) rotation of the power wheel, such as in the case when the user is riding the bicycle downhill, or he pedals the bicycle very fast, does not cause the motor in the wheel hub to rotate.

The eccentric gear module in the above embodiment helps to counterbalance the vibration caused by the bicycle during cycling and as a result the effect of such vibration to the motor will be minimized.

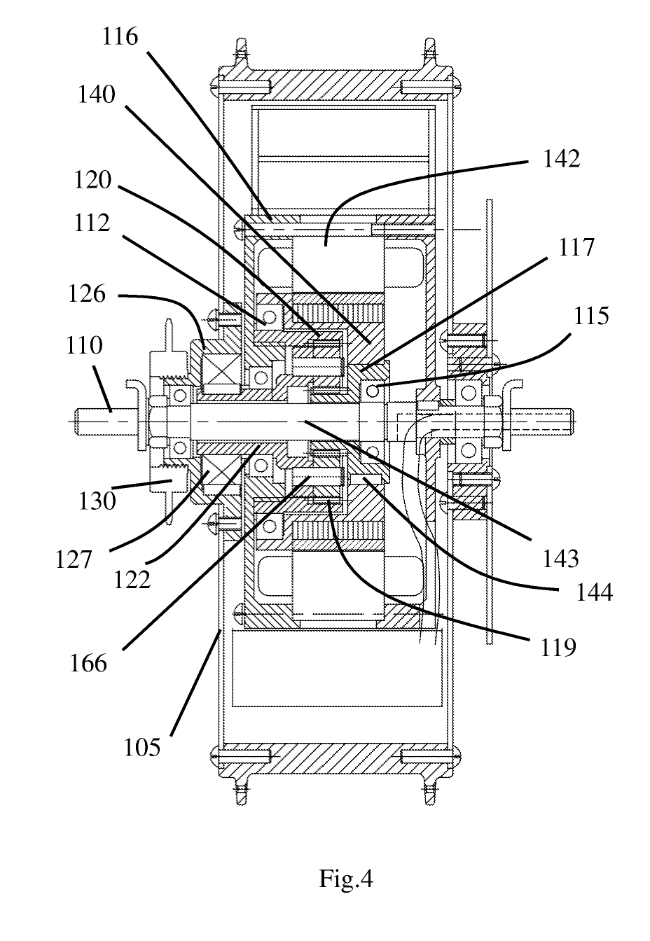

FIGS. 4-5 show a power wheel hub according to another embodiment of the present invention, where the wheel hub does not contain the eccentric gear module, but instead a planetary gear module. For the sake of brevity, only components of the wheel hub that are different from those as described with reference to FIGS. 2-3 will be described here. In this embodiment, the planetary gear module is contained within the rotor of the motor, but the one-way transmission module is not. In particular, the motor in the embodiment contains a stator 142 and a rotor 140. The rotor 140 is configured to be rotatable with respect to the axle 110, and is supported by a first bearing 112 on the motor housing 116. A sun gear 117 is supported on the axle 110 by a second bearing 115, and the sun gear 117 is fixedly connected to the rotor 140 by a flat key 144. The sun gear 117 engages with a plurality of planetary gears 119 which can revolve around the central axis 143 of the motor and also rotate around their respective rotating axis.

FIG. 5 shows the planetary module of the wheel hub in FIG. 3 in more details. There are three planetary gears 119, which are engaged with the sun gear 117 and an internal ring gear 120 at the same time. The internal ring gear 120 is fixed to the motor housing via threads and thus not rotatable. However, due to the engagement between the internal ring gear 120 and the planetary gears 119 the planetary gears 119 are able to rotate and revolve at the same time as a result of the sun gear 117 rotating. One can see that the internal ring gear 120, the sun gear 117, and the revolving movement of the planetary gears 119 all share the same central axis.

Turning back to FIG. 4, the internal ring gear 120 is fixed to the motor housing 116. Each planetary gear 119 is rotatably sleeved on a respective planetary shaft 166. The planetary shafts 166 are tightly pressed onto the output carrier 122. The output carrier 122 provides the output driving force of the gear reduction module. The output carrier 122 is coupled a connecting flange 126 via a one-way clutch 127. The connecting flange 126 is fixedly connected to both a side cover 105 of the hub housing and the sprocket 130 so that they rotate together in any event.

During operation, the rotor of the motor in the power wheel once energized will start to rotate around the central axis 143 due to change of magnetic flux between the stator 142 and the rotor 140. Next, as the sun gear 117 is fixedly connected to the rotor 140, the sun gear 117 rotates around the central axis 143. Since the planetary gears 119 are confined within the fixed internal ring gear 120, the planetary gears 119 rotate and revolve at the same time as a result of the sun gear 117 rotating. The planetary gears 119 then drive the output carrier 122 to rotate around the central axis 143 at a speed lower than that of the rotor 140 but at a torque higher than that of the rotor 140. The output carrier 122 then drives the connecting flange 126 to rotate via the one-way clutch 127, if the power wheel does not rotates or rotates at a speed slower than that of the connecting flange 126. In this case the one-way clutch 127 operates to transmit the power from the output carrier 122 to the connecting flange 126. The connecting flange 126 is fixed to the hub housing and in turn to the sprocket 130, so rotation of the connecting flange 126 causes the power wheel to rotate, thus moving the bicycle installed with the power wheel forward. During the whole process above the axle 110 is always still.

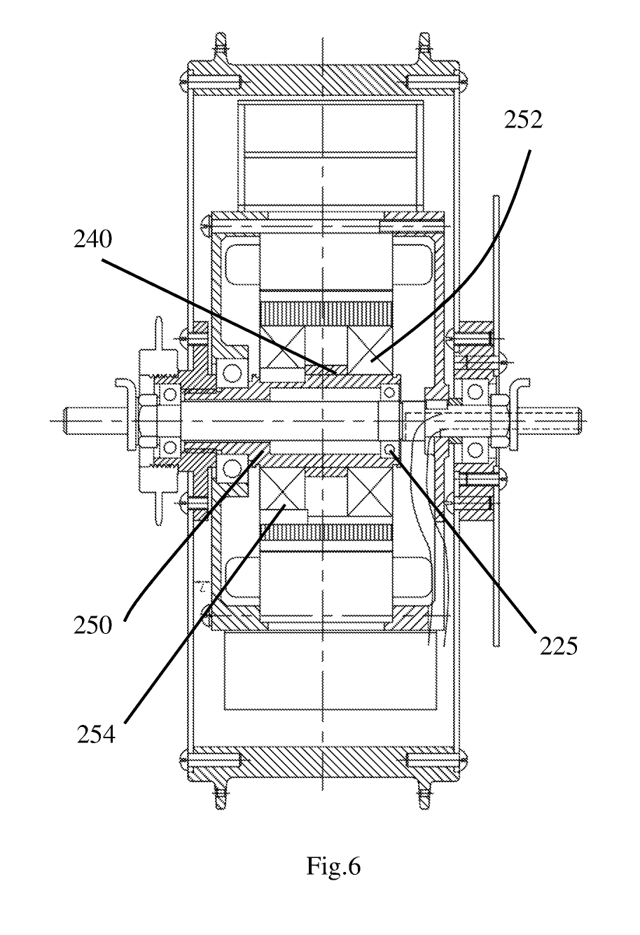

FIG. 6 illustrates a further embodiment of the present invention. For the sake of brevity, only components of the wheel hub that are different from those as described with reference to FIGS. 2-3 will be described here. In this embodiment there is no gear reduction modules present. Rather, the rotor 240 is directly support on a hollow shaft 250 of the motor via a first bearing 252, which is in turn supported on the axle 210 via a second bearing 225. The axle 210 passes through the hollow shaft 250 but these two do not rotate together. However, the rotor 240 drives the hollow shaft 250 to rotate only through a one-way bearing 254, but not through the bearing 252 which serves no driving power transmission functions. The hollow shaft 222 is coupled a connecting flange 226 which is fixedly connected to both a side cover of the hub housing 207 and the sprocket 230 so that they rotate together in any event.

During operation, the rotor 240 directly drives the motor shaft 222 through the one-way bearing 254, where the motor shaft 222 in turn drives the power wheel to rotate. The one-way bearing 254 just like other one-way transmission mechanisms allows the power to be transmitted from the rotor to the motor when the rotor is rotating at a speed higher than that of the wheel. However, when the power wheel rotates at a speed even faster than that of the speed of rotor, then the one-way bearing 254 is disabled and does not transmit the power from the rotor to the motor shaft. In consequence, the (faster) rotation of the power wheel, such as in the case when the user is riding the bicycle downhill, or he pedals the bicycle very fast, does not cause the motor in the wheel hub to rotate.

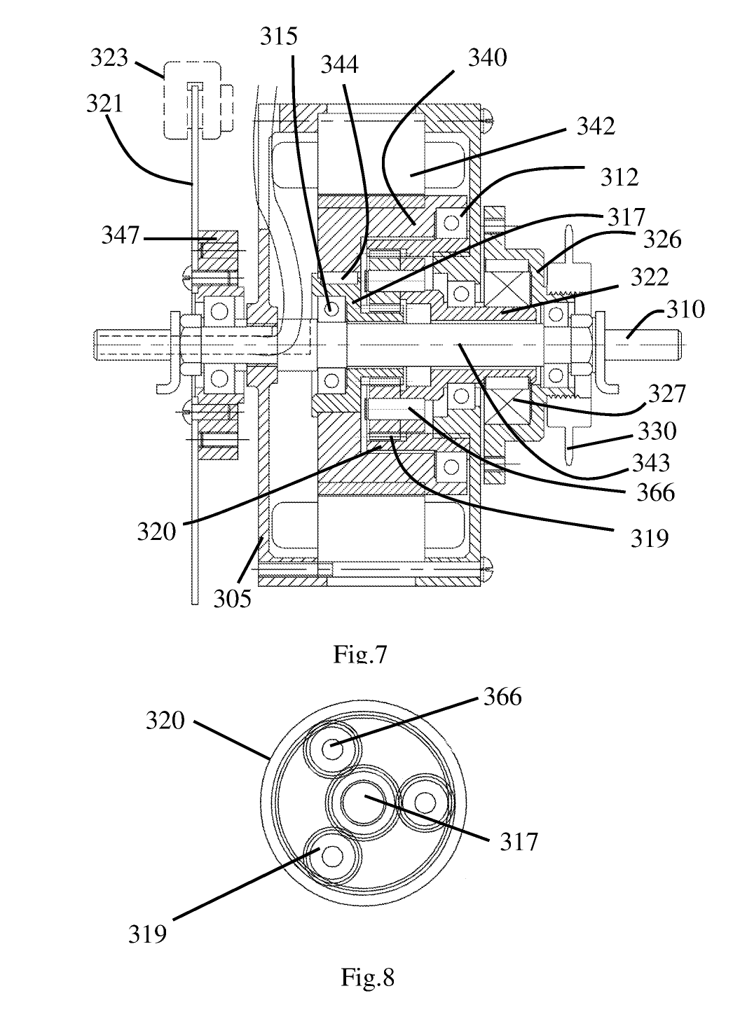

FIGS. 7-8 illustrate a further embodiment of the present invention of a motor in a power wheel hub. For the sake of brevity, only components of the motor that are different from those as described with reference to FIGS. 2-3 will be described here. In particular, the motor in the embodiment contains a stator 342 and a rotor 340. The rotor 340 is configured to be rotatable with respect to the axle 310, and is supported by a first bearing 312 on the motor housing 316. A sun gear 317 is supported on the axle 310 by a second bearing 315, and the sun gear 317 is fixedly connected to the rotor 340 by a flat key 344. The sun gear 317 engages with a plurality of planetary gears 319 which can revolve around the central axis 343 of the motor and also rotate around their respective rotating axis. Similar to the power wheel hub shown in FIG. 2, in FIG. 7 the power wheel hub has on its one end a sprocket 330 and on its other end a braking flange 347. The sprocket 330 is rotatable together with a side cover 305 of the hub housing. The sprocket 330 is capable of engaging with a chain (not shown) of a bicycle as those skilled in the art would understand. The braking flange 347 has an extension part 321 which is in a disc shape. The extension part 321 can be used for performing braking actions to the power wheel by a disc brake 323 as those skilled in the art is familiar with.

FIG. 8 shows the planetary module of the motor in FIG. 7 in more details. There are three planetary gears 319, which are engaged with the sun gear 317 and an internal ring gear 320 at the same time. The internal ring gear 320 is fixed to the motor housing via threads and thus not rotatable. However, due to the engagement between the internal ring gear 320 and the planetary gears 319 the planetary gears 319 are able to rotate and revolve at the same time as a result of the sun gear 317 rotating. One can see that the internal ring gear 320, the sun gear 317, and the revolving movement of the planetary gears 319 all share the same central axis.

Turning back to FIG. 7, the internal ring gear 320 is fixed to the motor housing 316. Each planetary gear 319 is rotatably sleeved on a respective planetary shaft 366. The planetary shafts 366 are tightly pressed onto the output carrier 322. The output carrier 322 provides the output driving force of the gear reduction module. The output carrier 322 is coupled a connecting flange 326 via a one-way clutch 327. The connecting flange 326 is fixedly connected to both the side cover 305 of the hub housing and the sprocket 330 so that they rotate together in any event.

During operation, the rotor of the motor in the power wheel once energized will start to rotate around the central axis 343 due to change of magnetic flux between the stator 342 and the rotor 340. Next, as the sun gear 317 is fixedly connected to the rotor 340, the sun gear 317 rotates around the central axis 343. Since the planetary gears 319 are confined within the fixed internal ring gear 320, the planetary gears 319 rotate and revolve at the same time as a result of the sun gear 317 rotating. The planetary gears 319 then drive the output carrier 322 to rotate around the central axis 343 at a speed lower than that of the rotor 340 but at a torque higher than that of the rotor 340. The output carrier 322 then drives the connecting flange 326 to rotate via the one-way clutch 327, if the power wheel does not rotates or rotates at a speed slower than that of the connecting flange 326. In this case the one-way clutch 327 operates to transmit the power from the output carrier 322 to the connecting flange 326. The connecting flange 326 is fixed to the hub housing and in turn to the sprocket 330, so rotation of the connecting flange 326 causes the power wheel to rotate, thus moving the bicycle installed with the power wheel forward. During the whole process above the axle 310 is always still.

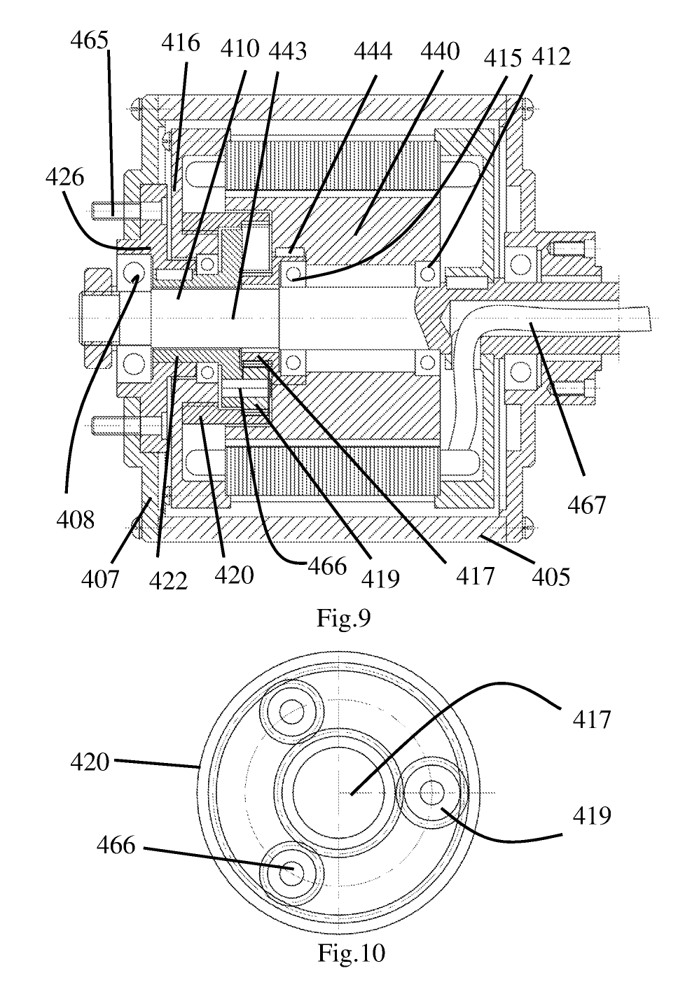

Turning now to FIGS. 9-10, another embodiment of the present invention show a wheel hub for a power wheel suitable for using on an automobile. For the sake of brevity, only components of the motor that are different from those as described with reference to FIGS. 2-3 will be described here. In particular, in this embodiment components necessary for bicycles are not present, including but not limited to sprocket, chains, etc. Also, in the power wheel hub shown in FIGS. 9-10 the power supply for operating the motor in the wheel hub is placed outside the wheel hub, for example in a location in the automobile. The electrical power is transmitted from the power supply to the motor via wires 467. The wheel hub as shown contains a circular top cover 405, which are fixed to two side covers 407 to form the wheel hub housing. A plurality of wheel studs 465 secure a connecting flange 426 to the hub housing so that they can rotate at the same time. The wheel studs 465 as skilled persons would understand are used for installing wheels of the automobile on the wheel hub.

The motor is located in wheel hub with no space left for placing other components such as batteries. The motor contains a motor housing 416 inside which a stator 442 and a rotor 440 are configured. The motor housing 416 has a similar structure as that of the wheel hub housing. The rotor 440 is configured to be rotatable with respect to the axle 410, and is supported by one or more first bearings 412 on the axle 410. A sun gear 417 is supported on the axle 410 by one or more second bearings 415, and the sun gear 417 is fixedly connected to the rotor 440 by a flat key 444. The sun gear 417 engages with a plurality of planetary gears 419 which can revolve around the central axis 443 of the motor and also rotate around their respective rotating axis.

FIG. 10 shows the planetary module of the motor in FIG. 9 in more details. There are three planetary gears 419, which are engaged with the sun gear 417 and an internal ring gear 420 at the same time. The internal ring gear 420 is fixed to the motor housing via threads and thus not rotatable. However, due to the engagement between the internal ring gear 420 and the planetary gears 419 the planetary gears 419 are able to rotate and revolve at the same time as a result of the sun gear 417 rotating. One can see that the internal ring gear 420, the sun gear 417, and the revolving movement of the planetary gears 419 all share the same central axis.

Turning back to FIG. 9, the internal ring gear 420 is fixed to the motor housing 416. Each planetary gear 419 is rotatably sleeved on a respective planetary shaft 466. The planetary shafts 466 are tightly pressed onto the output carrier 422. The output carrier 422 provides the output driving force of the gear reduction module. The connecting flange 426 is then connected to the side cover 407 of the hub housing as mentioned previously.

During operation, the rotor of the motor in the power wheel once energized will start to rotate around the central axis 443 due to change of magnetic flux between the stator 442 and the rotor 440. Next, as the sun gear 417 is fixedly connected to the rotor 440, the sun gear 417 rotates around the central axis 443. Since the planetary gears 419 are confined within the fixed internal ring gear 420, the planetary gears 419 rotate and revolve at the same time as a result of the sun gear 417 rotating. The planetary gears 419 then drive the output carrier 422 to rotate around the central axis 443 at a speed lower than that of the rotor 440 but at a torque higher than that of the rotor 440. The output carrier 422 then drives the connecting flange 426 to rotate.

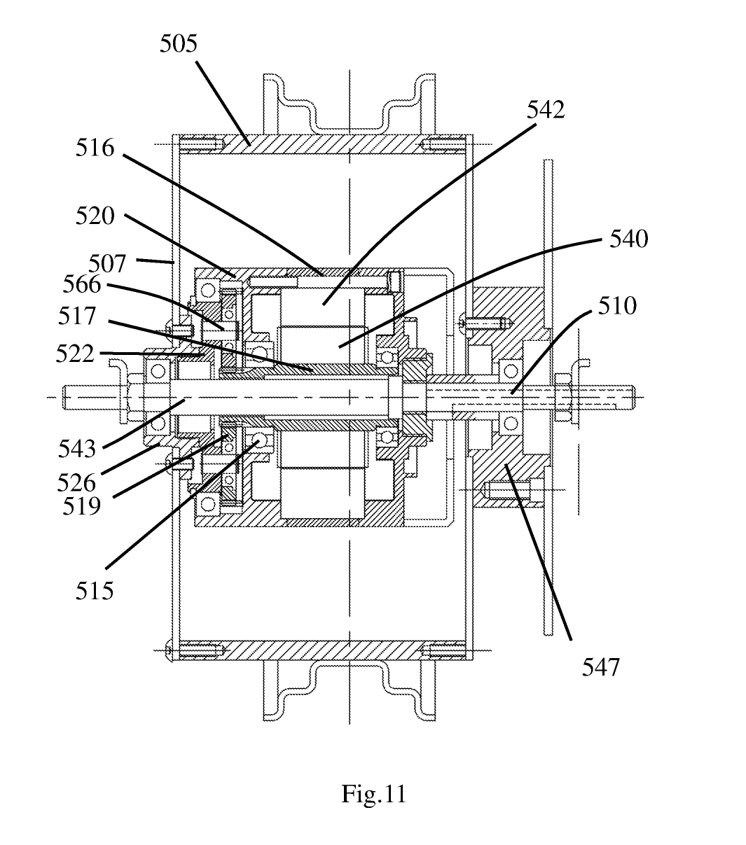

Turning now to FIG. 11, another embodiment of the present invention show a wheel hub for a power wheel suitable for using on an electric motorcycle. For the sake of brevity, only components of the motor that are different from those as described with reference to FIGS. 2-3 will be described here. The wheel hub as shown contains a circular top cover 505, which are fixed to two side covers 507 to form the wheel hub housing. A motor housing 516 is arranged coaxially with the hub housing and placed inside the hub housing. There are some other spaces between the motor housing 516 and the top cover 505 for accommodating components like batteries of the power wheel. The motor contains a stator 542 and a rotor 540. The rotor 540 is configured to be rotatable with respect to the axle 510.

In this embodiment, the gear reduction module is no longer placed inside the rotor 540 of the motor. Rather, the gear reduction module is placed inside the motor housing 516 but outside the rotor 540 and the stator 542. In particular, a sun gear 517 is supported on the axle 510 by one or more second bearings 515. The sun gear 517 engages with a plurality of planetary gears 519 which can revolve around the central axis 543 of the motor and also rotate around their respective rotating axis. An internal ring gear 520 is fixed to the motor housing 516. Each planetary gear 519 is rotatably sleeved on a respective planetary shaft 566. The planetary shafts 566 are tightly pressed onto the output carrier 522. The output carrier 522 provides the output driving force of the gear reduction module to a connecting flange 526, which is then connected to the side cover 507 of the hub housing. On an end of the axle 510, there is connected a braking flange 547 which is fixedly connected to the wheel hub housing.

During operation, the rotor of the motor in the power wheel once energized will start to rotate around the central axis 543 due to change of magnetic flux between the stator 542 and the rotor 540. Next, as the sun gear 517 is fixedly connected to the rotor 540, the sun gear 517 rotates around the central axis 543. Since the planetary gears 519 are confined within the fixed internal ring gear 520, the planetary gears 519 rotate and revolve at the same time as a result of the sun gear 517 rotating. The planetary gears 519 then drive the output carrier 522 to rotate around the central axis 543 at a speed lower than that of the rotor 540 but at a torque higher than that of the rotor 540. The output carrier 522 then drives the connecting flange 526 to rotate.

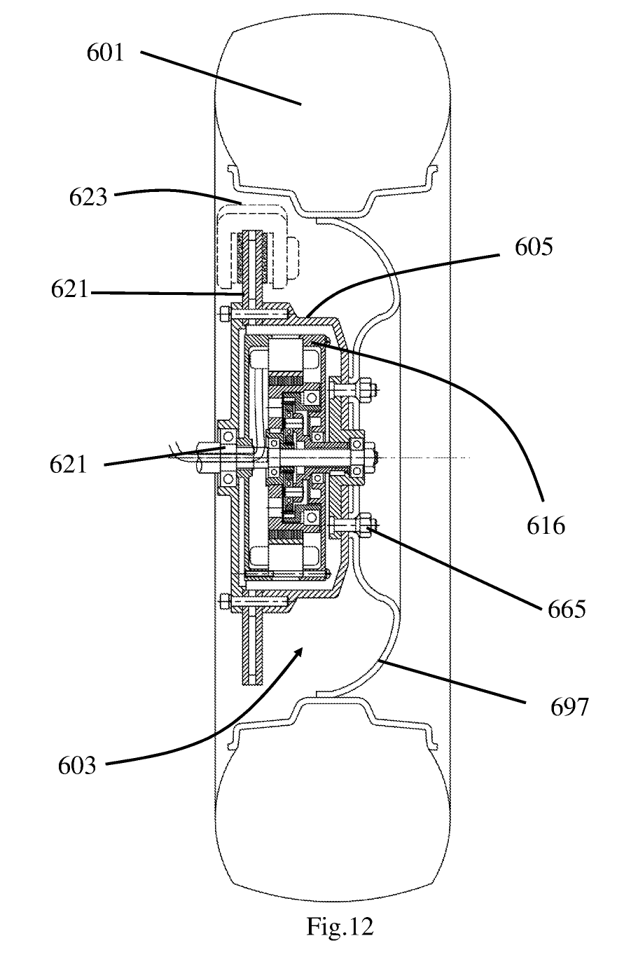

Turning now to FIG. 12, a further embodiment of the present invention show a power wheel suitable for using on an automobile. For the sake of brevity, only components of the motor that are different from those as described with reference to previous figures will be described here. The power wheel shown in FIG. 12 is different from that shown in FIGS. 9-10 in that the power wheel in FIG. 12 adopts an in-rotor design for the gear reduction mechanisms, similar to those shown in FIGS. 1-8. The motor in the power wheel in FIG. 12 has a structure most similar to that in FIG. 4, which uses a planetary gear system residing within the rotor to reduce the output speed of the motor. There is no battery module placed between the motor housing 616 and the wheel hub housing 605. Rather, the battery module for driving the vehicle is located in a different location in the vehicle frame (not shown) since the battery capacity needed to drive the vehicle and to ensure a desired endurance. Near one end of the axle 610, there is an extension part 621 extending along a radially outward direction which is formed on the wheel hub housing 605. The extension part 621 is adapted to engage with a disc brake 623 to perform braking actions. The entire wheel hub 603 is accommodated within the space formed by the wheel trim 697 and detachably secured to the same by multiple screws 665. On the circumferential surface of the wheel trim 697, there is covered the tyre 601.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

For example, the power wheels as described and illustrated in FIGS. 1-8 are made into standard bicycle wheel size. However, it is clear that for other types of vehicles, the power wheels according to the present invention can also be made into other dimensions, such as with different radius and width (when looking along the radial direction). In particular, the housing of the power wheel hub can be designed to have a larger radius and/or width, therefore providing more or less interior space for accommodating the battery cells.

In a variation of the present invention, the bicycle on which power wheels are installed do not have the sprocket and chain system for driving the wheels using pedaling force. Rather, an electrical generator is coupled to the pedals so that the pedaling action by the cyclist causes the generator to generate electric power. The electric power is then transmitted to the battery module for recharging the battery module. At the same time, the pedals are connected to a sensor which is able to generate control commands to the power wheel controller according to the force, speed, torque, etc. of the pedals. The power wheel may then be controlled according to the commands generated by the pedaling actions of the cyclist.

In the preferred embodiments described above, the power wheels are installed on a bicycle. No doubt that the power wheels may also be used in other types of vehicle to achieve self-propelling, such as unicycle, bicycle, tricycle, or four-wheel vehicle.

1. A wheel hub capable of being coupled to an axle of a wheel such that the wheel hub is rotatable around the axle, the wheel hub comprising:
a) a hub housing adapted to be rotatably supported on the axle;
b) a motor comprising a stator and a rotor; the stator adapted to be fixedly connected to the axle; the rotor configured to be rotatable with respect to the stator;
wherein the rotor comprising a circular rotor housing inside which a gear reduction module is located; the output of the gear reduction module connected to a one-way transmission module which in turn is adapted to drive the hub housing to rotate.

2. The wheel hub of claim 1, wherein the gear reduction module further comprises an eccentric gear module; an input of the eccentric gear module connected to the rotor housing; an output of the eccentric gear module connected to the one-way transmission module.

3. The wheel hub of claim 2, wherein the eccentric gear module further comprises an eccentric gear adapted to be rotatably supported on the axle; the eccentric gear fixedly connected to the rotor housing and being drivable by the latter to rotate.

4. The wheel hub of claim 3, wherein the eccentric gear is coupled to an external ring gear via a connecting member; the external ring gear adapted to revolve within an internal ring gear fixedly mounted on the hub housing.

5. The wheel hub of claim 4, wherein the external ring gear comprises external teeth; the internal ring gear comprising internal teeth; only a part of the external teeth engaging with only a part of the internal teeth at any time; the external ring gear having a central axis offset from that of the internal ring gear.

6. The wheel hub of claim 5, wherein the number of the external teeth is smaller than that of the internal teeth.

7. The wheel hub of claim 5, wherein the external ring gear is coupled to an output carrier to drive the latter to rotate; the output carrier coupled to the one-way transmission module to provide the output of the gear reduction module thereto; the output carrier having a same axis of rotation with the rotor.

8. The wheel hub of claim 1, wherein the gear reduction module is a planetary gear module; an input of the planetary gear module connected to an output shaft of the motor; an output of the planetary gear module connected to the hub housing.

9. The wheel hub of claim 8, wherein the planetary gear module further comprises a sun gear adapted to be rotatably supported on the axle; the sun gear fixedly connected to the rotor housing and being drivable by the latter to rotate.

10. The wheel hub of claim 9, wherein the sun gear is coupled to a plurality of planetary gears confined by an internal ring gear fixedly mounted on the hub housing; the planetary gears adapted to revolve around the sun gear within the internal ring gear.

11. The wheel hub of claim 10, wherein the plurality of planetary gears are coupled to an output carrier to drive the latter to rotate; the output carrier coupled to the one-way transmission module to provide the output of the gear reduction module thereto; the output carrier having a same axis of rotation with the axle.

12. The wheel hub of claim 1, wherein the one-way transmission module is a one-way transmission clutch.

13. The wheel hub of claim 1, wherein the one-way transmission module is a one-way bearing supporting the gear reduction module on the hub housing.

14. The wheel hub of claim 13, wherein the one-way bearing is at least partially received in the rotor housing.

15. The wheel hub of claim 1, further comprises a sprocket fixedly connected to the housing; the sprocket adapted to be connected to and driven by an external chain.

16. A power wheel which is adapted to be coupled to a vehicle frame, comprising:
a) an axle for connecting the power wheel to the vehicle frame;
b) a wheel hub according to claim 1; and
c) a rim fixedly connected to a hub housing of the wheel hub.

17. The power wheel of claim 16, further comprises a plurality of spokes; the housing of the wheel hub connected to the rim by the plurality of spokes.

18. A wheel hub capable of being coupled to an axle of a wheel such that the wheel hub is rotatable around the axle, the wheel hub comprising:
a) a hub housing adapted to be rotatably supported on the axle;
b) a motor comprising a stator and a rotor; the stator adapted to be fixedly connected to the axle; the rotor configured to be rotatable with respect to the stator;
wherein the rotor comprising a rotor housing; the rotor further comprising a one-way transmission module and a bearing which are located within the rotor housing.

19. The wheel hub of claim 18, wherein the one-way transmission module and the bearing couple the rotor to an output carrier; the output carrier fixedly connected to the hub housing and adapted to drive the latter to rotate with respect to the axle.

20. The wheel hub of claim 19, wherein the one-way transmission module and the bearing are aligned along an axial direction of the motor.

21. The wheel hub of claim 20, wherein the one-way transmission module is a one-way bearing.

22. A power wheel which is adapted to be coupled to a vehicle frame, comprising:
a) an axle for connecting the power wheel to the vehicle frame;
b) a wheel hub according to claim 18; and
c) a rim fixedly connected to a hub housing of the wheel hub.

23. The power wheel of claim 22, further comprises a plurality of spokes; the housing of the wheel hub connected to the rim by the plurality of spokes.
